(19) United States
(12) Patent Application Publication
(10) Pub. No.: US 2002/0090599 A1
(43) Pub. Date: Jul. 11, 2002

(54) Schemata of the elements and of the periodic table of the elements with scrolling apparatus for elements one through 504

(76) Inventor: Charles William Johnson, Jefferson, LA (US)

Correspondence Address: Charles William Johnson, 360 Jefferson Heights Avenue, Jefferson, LA, 70121, US

(21) Appl. No.: 09/900,670

(22) Filed: Jul. 6, 2001

Related U.S. Application Data
(60) Provisional application No. 60/217,446, filed on Jul. 10, 2000.
(60) Provisional application No. 60/217,566, filed on Jul. 12, 2000.

(51) Int. Cl. G09B 23/26

(52) U.S. Cl. 434/282

(57) ABSTRACT

The Schemata of the Elements and the Schemata of the Periodic Table of the Elements presents an apparatus for rendering and visualizing quantitative and qualitative data onto the schema format of color-coded squares that represent the individual elements and their atoms. The schemata render not only the aspect of periodicity of the elements, but innumerable other features of the elements into patterns of translation and reflective symmetry, derived from the sequential, progressive numerical ordering of the atomic and electronic numbers of the elements. The inner and the outer transition elements are brought into the main body of the representative elements, thus discerning the predictive tendencies within the behavior of the elements. The schemata present the cycles for projected elements of schemata of 166, 216, and 502 elements, inclusively and theoretically for all elements from one to 502. The conventional periodic table discerns certain patterns of irregularity, which when rendered onto the schemata are discerned to be quite regular in nature, thereby correcting many misconceptions about the nature of the elements. New and original data rendered onto the schemata produce relationships of anomalies never before discerned until rendered onto the schemata. The schemata establish projections of incremental and decremental tendencies among the elements and their atoms.

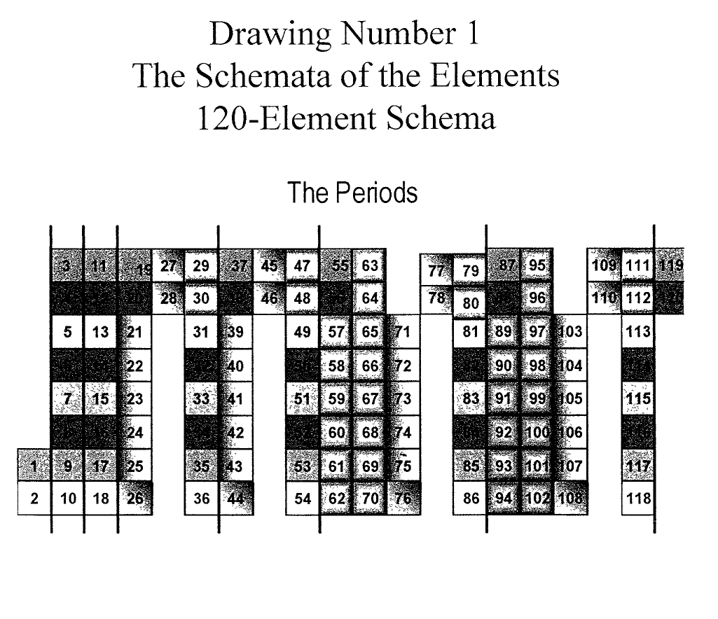

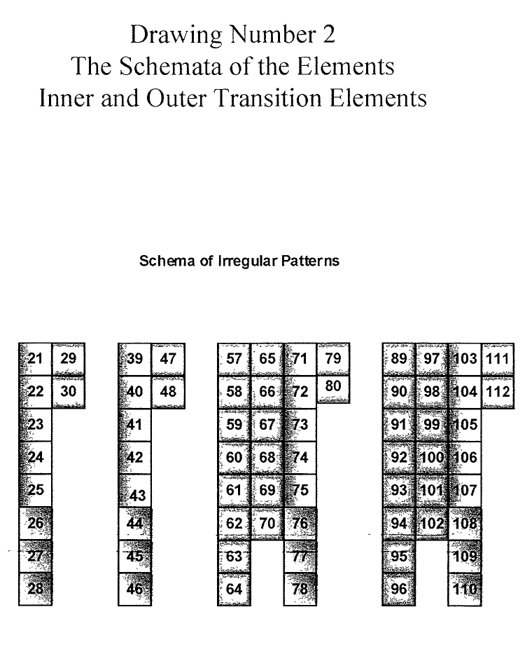

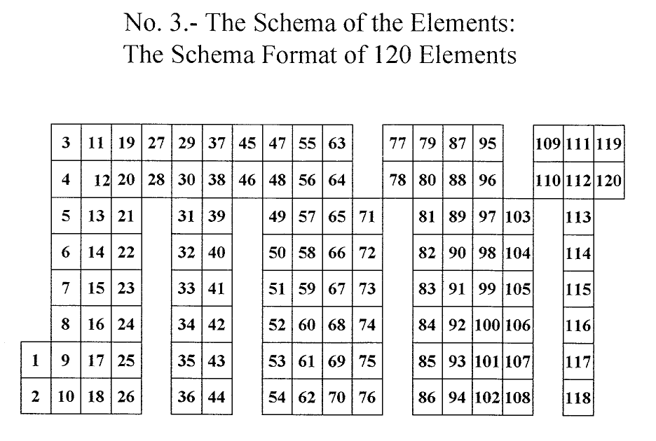

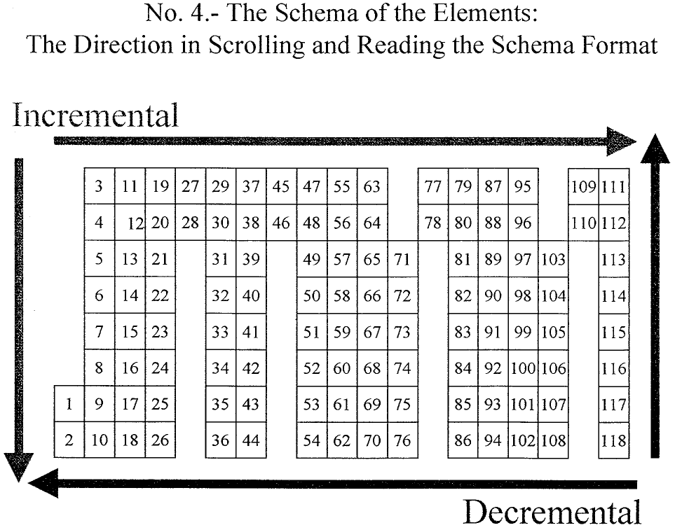

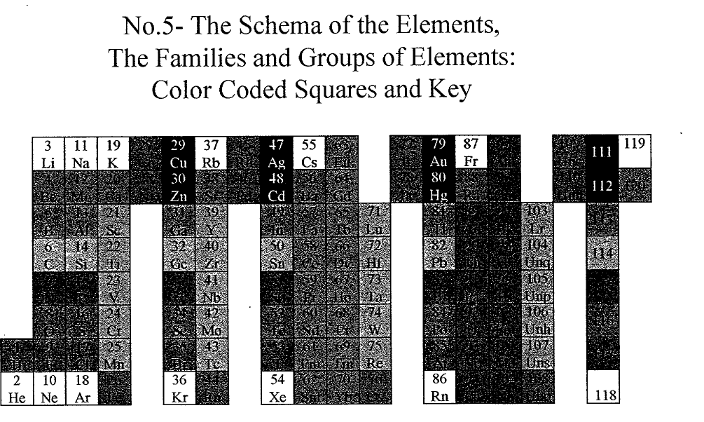

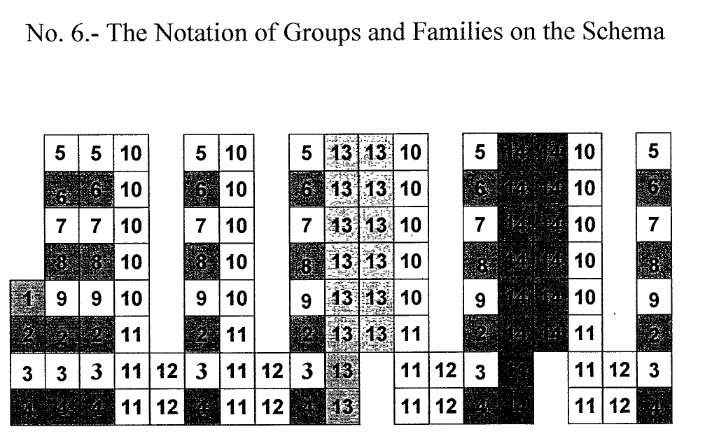

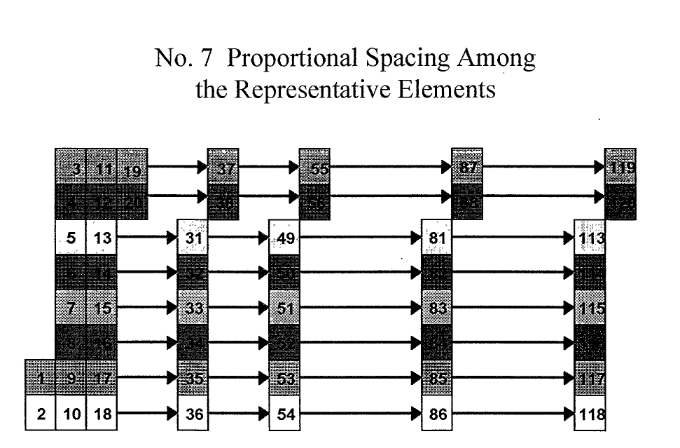

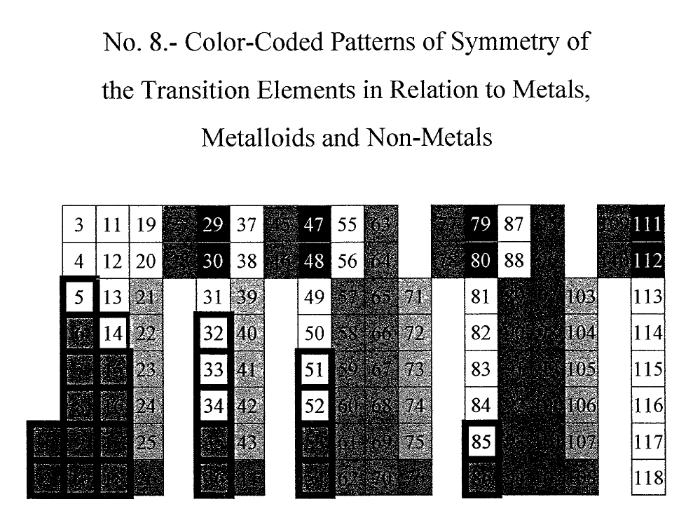

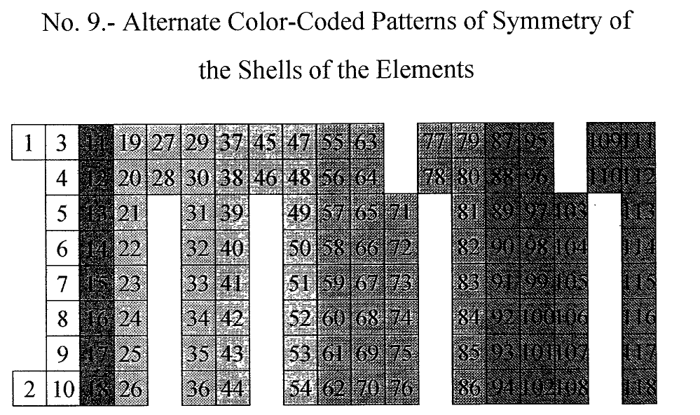

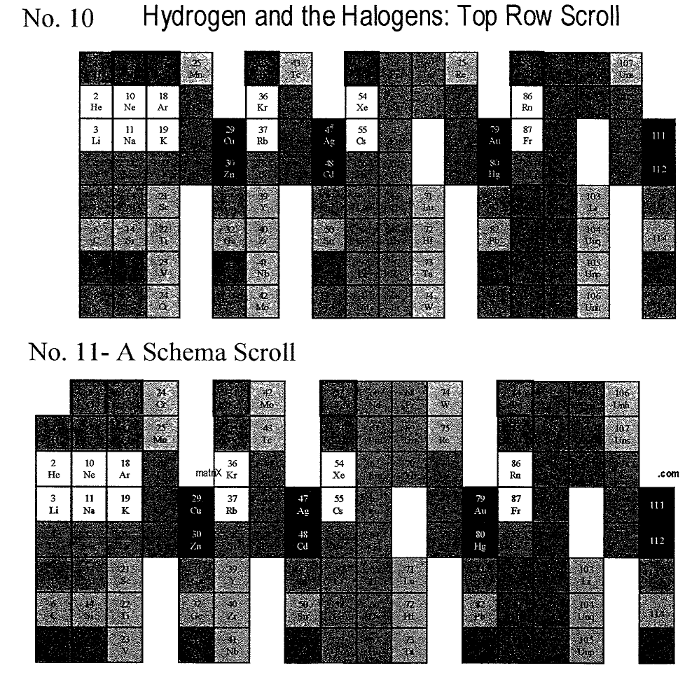

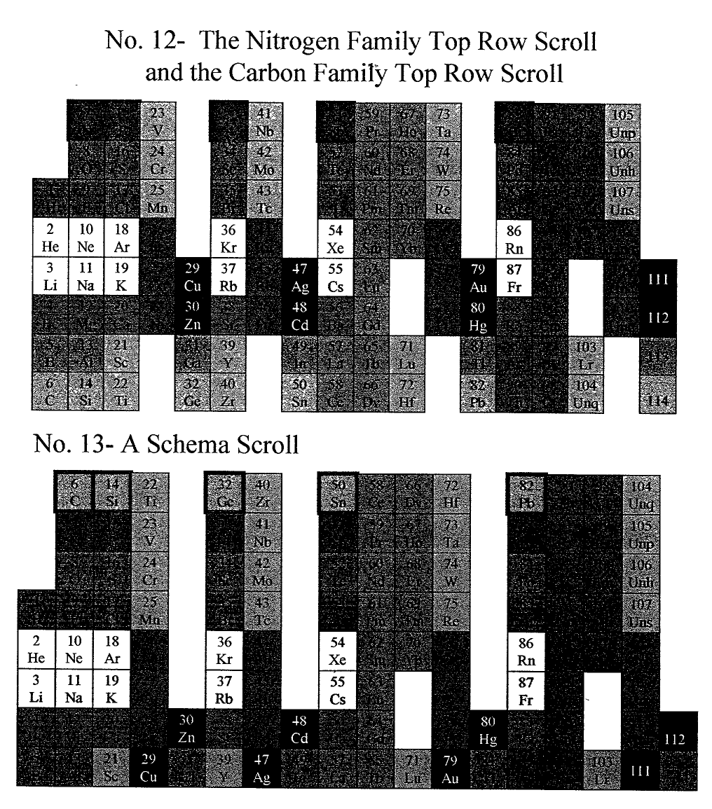

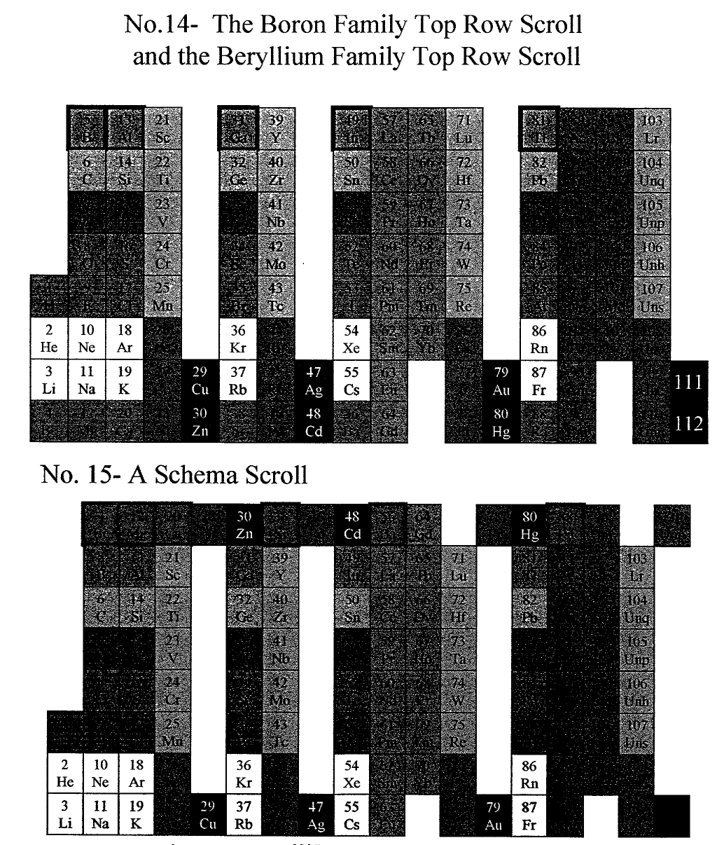

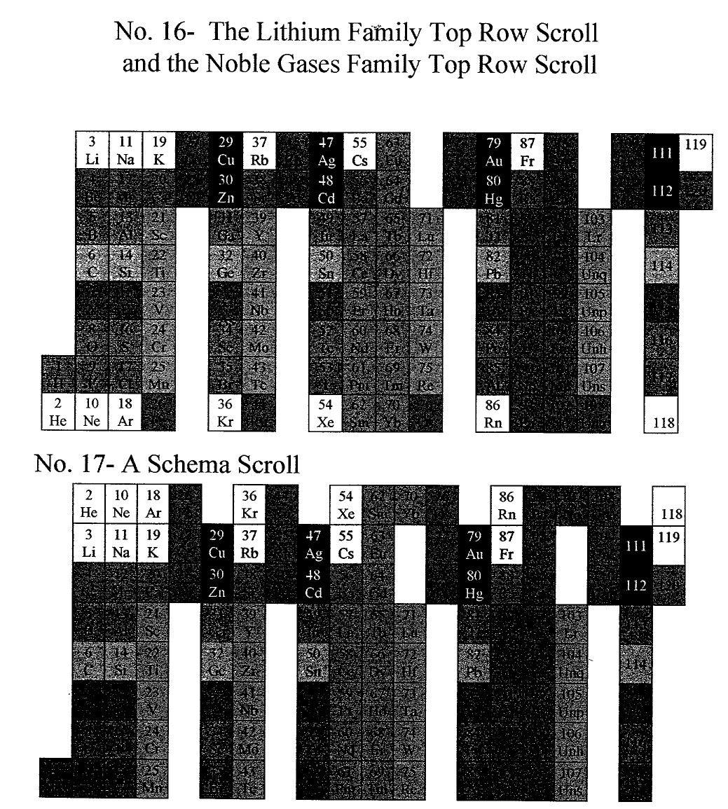

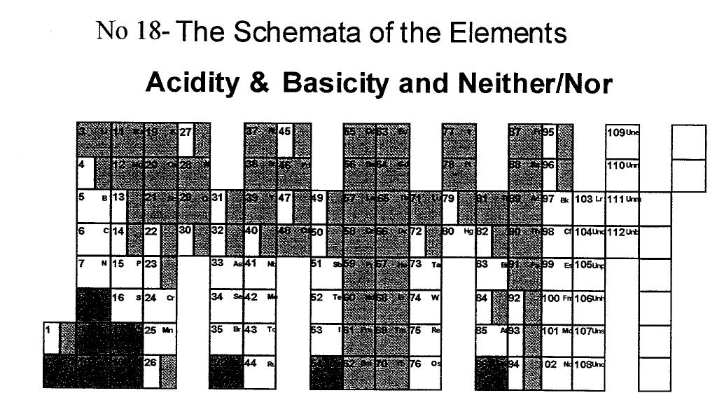

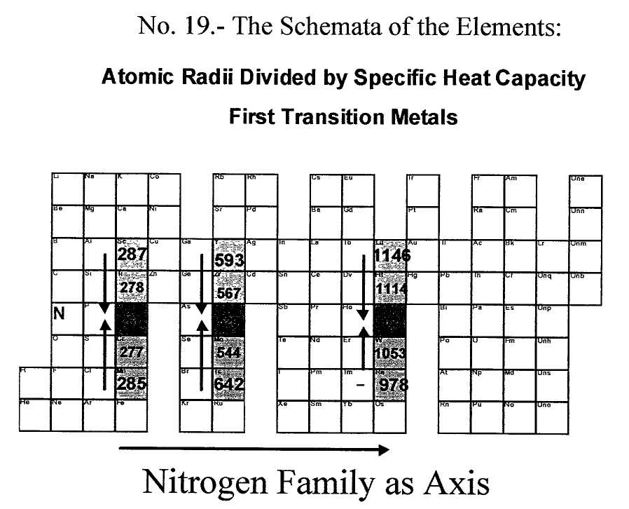

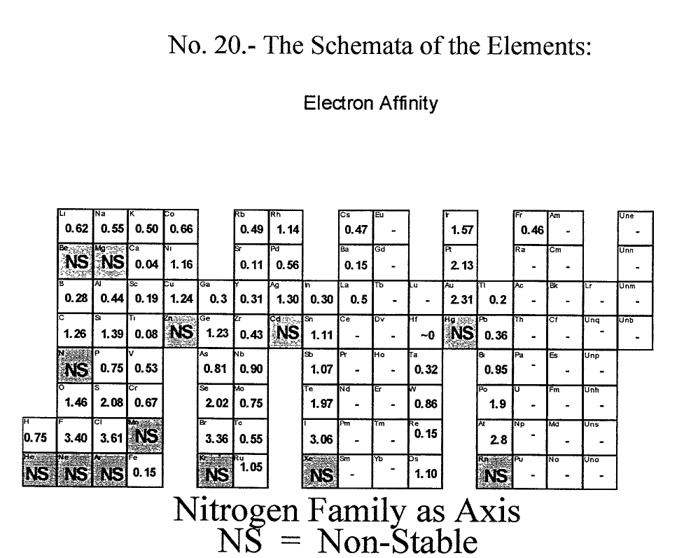

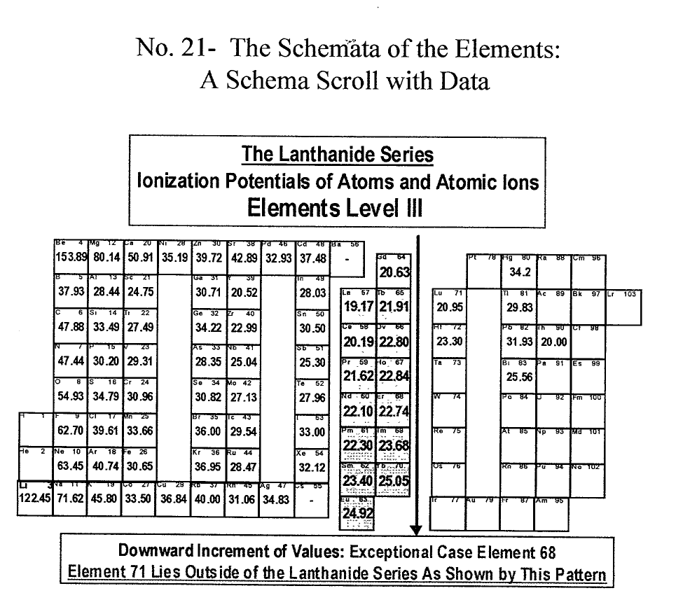

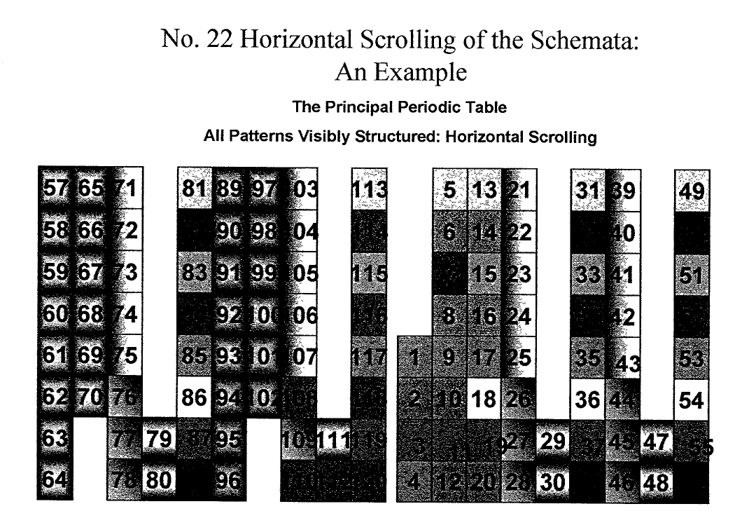

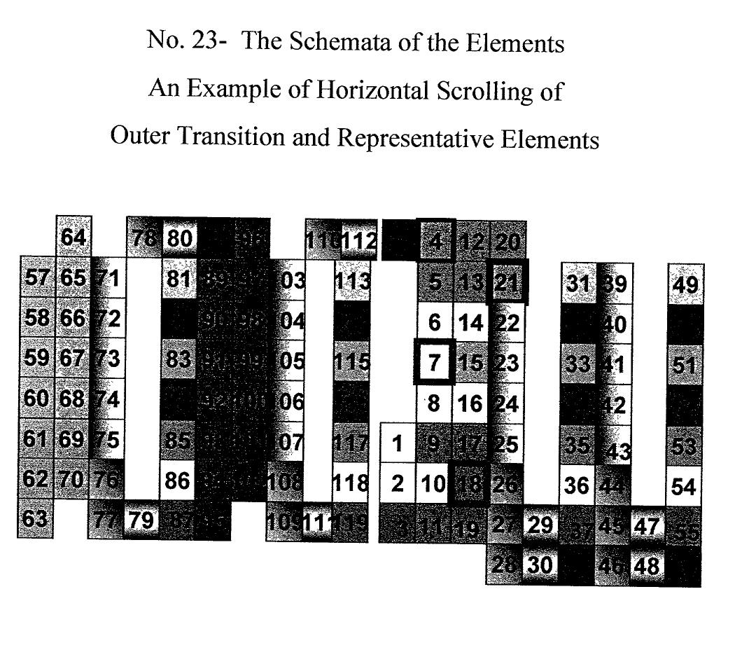

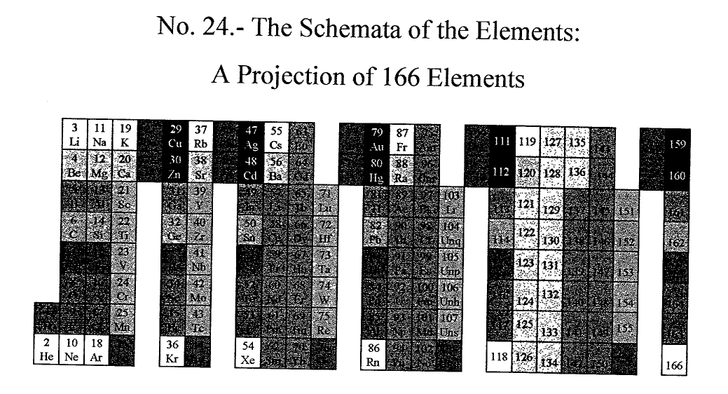

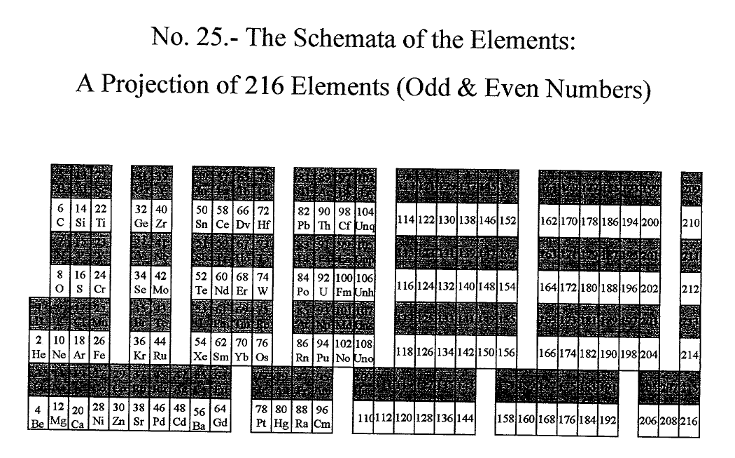

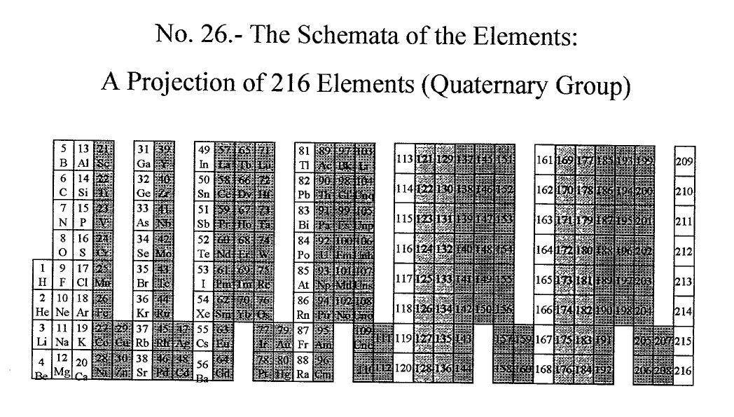

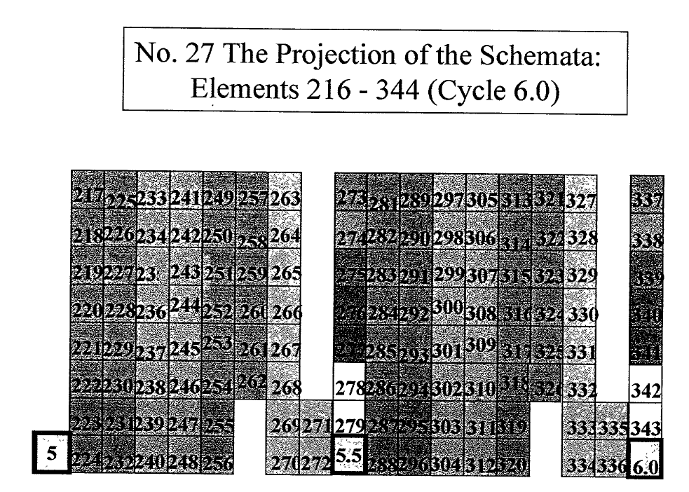

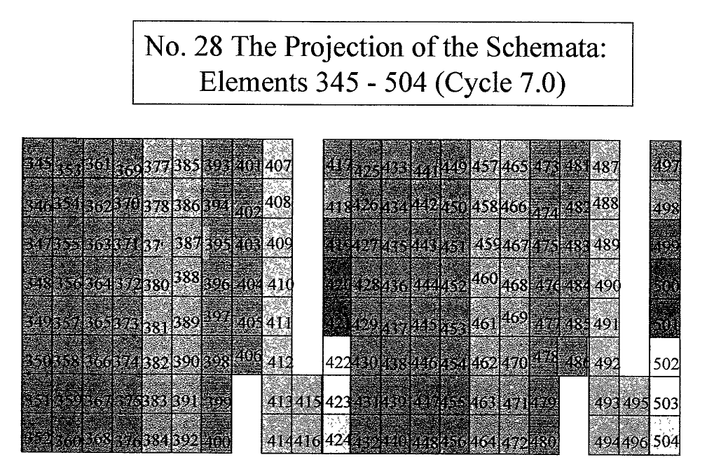

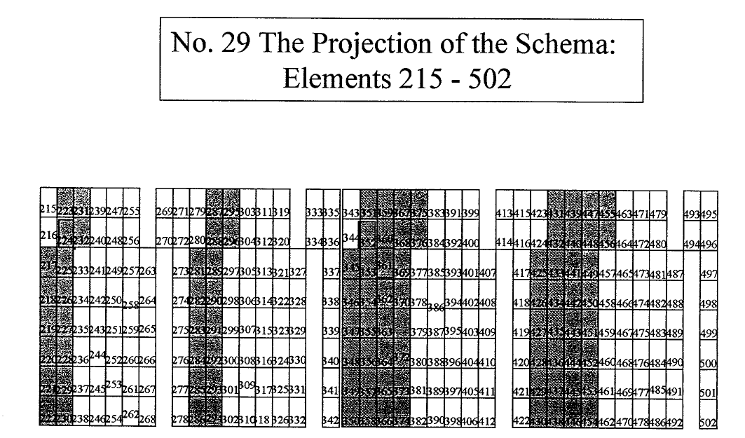

### BACKGROUND TO THE INVENTION

The apparatus and process used in scientific and technical skills development for data processing, for The Schemata of the Elements and of the Periodic Table of the Elements with Scrolling Device for Elements One Through 504, are presented in this utility patent application. The periodicity and patterns of the elements are described in terms of color-coded squares, which represent each one of the elements (numbered one through 504). The color-coded squares may be scrolled in a manner to render visual images of their behavioral relationships. Original relationships among the elements and their characteristics are generated through the rearrangement of the placement of the elements in a progressively sequential numerical format, based on the atomic number and electronic configuration number of each element.

The visualization of spatial patterns and relationships generates new knowledge about the elements and, provides a research and learning tool. The schematic presentation of the elements on the schema format enables researchers to generate new knowledge and allows students to commit to memory the recall of the color-coded, visual patterns. The regular and irregular patterns of the Mendeleev periodic table, in use today, are rearranged according to various aspects of the elements, whereby the elements now produce and render completely regular and symmetrical patterns. These color-coded, visual patterns are new and original, absent until now in the literature in the fields of chemistry and physics.

The schemata of the elements reveal a specific regularity in their make-up, which allows for the predictive nature of the periodic table to be regained. A schema format of the elements in a database allows for relating elements that have been unrelated in the past. The schemata enable a correspondence among the elements beyond the simple periodicity of the elements. The schemata of the elements are a multiple faceted diagram and progressive numeric flow-chart depicting, through color-coded spatial elements, the different aspects proposed to conceptualize the atomic structure of the elements, neutrons, and protons of the atoms.

The schemata show the distribution patterns for each of the recognized 120 elements of a conventional periodic table of the elements, as well as for the predicted elements up to and including element 504 of the Schemata of the Elements described herein. The distribution patterns are presented in a schematic form with rows or columns number one through number eight of the elements and their atomic symbols and numbers. The schemata present the elements of the conventional periodic table of the elements in a distinct order as described herein, from the common order of the conventional periodic table of the elements.

Prior representations of the periodic table of the elements may be viewed in a classical text on the history of the periodic table by, professor Edward G. Mazurs, Graphic Representations of the Periodic System During One Hundred Years, The University of Alabama Press, University, Alabama, 1957, 251+ pages, ISBN 0-8173-3200-6.

### REFERENCES

### U.S PATENT DOCUMENTS

Utility Patents Background Documents:

REFERENCES
U.S. PATENT DOCUMENTS
Utility Patents Background Documents:

| | | | |
|---|---|---|---|
| 660,255 | October, 1900 | Kingma | 434/185 |
| 1,087,336 | February, 1914 | Thurber | 434/430 |
| 1,590,998 | June, 1926 | Balston | 400/99 |
| 2,052,457 | August, 1936 | French | 434/278 |
| 2,085,881 | July, 1937 | Van Doren | 434/278 |
| 2,516,418 | July, 1950 | Ramsay | 434/281 |
| 2,651,115 | September, 1953 | Davies | 434/281 |
| 2,891,322 | June, 1959 | Brownlee | 434/282 |
| 2,920,401 | January, 1960 | Lennon | 434/281 |
| 3,156,985 | September 1964 | Bliss, et.al. | 434/282 |
| 3,183,608 | May, 1965 | Jierree | 434/278 |
| 3,325,914 | June, 1967 | Bliss, et.al. | 434/278 |
| 3,390,468 | July, 1968 | Mitchell | 434/282 |
| 3,406,972 | October, 1968 | Wong | 273/118A |
| 3,654,708 | April, 1972, | Brudner | 434/307 |
| 3,866,337 | February, 1975 | Burns | 434/281 |
| 4,193,423 | March, 1980 | Al-Kufaishi | 434/178 |
| 4,568,288 | February, 1986 | Patterson | 434/366 |
| 4,650,423 | March 1987, | Sprague, et.al. | 434/156 |
| 5,201,046 | April, 1993 | Goldberg, et.al. | 395/600 |
| 5,261,080 | November, 1993 | Khoyi, et.al. | 395/500 |
| 5,418,948 | May, 1995 | Turtle | 395/606 |
| 5,446,880 | August, 1995 | Balgeman, et.al. | 395/600 |
| 5,499,371 | March, 1996 | Henninger, et.al | 395/700 |

Design Patents Background

| | | | |
|---|---|---|---|
| D117,149 | October, 1939 | Robin | D20/10 |
| D146,369 | February, 1947 | Millott | D6/470 |
| D266,465 | October, 1962 | Cordony, et.al. | D6/300 |
| D359,988 | July, 1995 | Lechleitter, et.al. | D20/10 |
| D360,230 | July, 1995 | Lechleitter, et.al. | D20/10 |

U.S. Pat. No. 4,810,197, “Three-Dimensional instructional device for teaching physical properties and relationships between basic elements”, Mar. 7, 1989. Inventor: Alfonza Hicks. Current U.S. Classification: 434/281; 434/278. International Classification: G09B 23/24; G09B 23/26.

Patent D370,128, “Three Dimensional Periodic Charts Support and Container”, May 28, 1996.; Inventor: Alexander Roy. Current U.S. Classification: D6/300; D6/482; D6/495; D19/77; D19/85.

U.S. Pat. No. 4,831,525, “Method of generating a source program from inputted schematic information”, May 16, 1989. Inventors: Saito, Kazumasa, Maezawa, Hiroyuki; Kobayashi, Masakazu; Futamura, Yoshihiko. Current US Classification: 717/3; 707/100; 717/7

U.S. Pat. No. 5,382,166, “Electron-space diagram and display model”, Jan. 17, 1995. Inventor: Ahmose, Rhamal. Current US classification: 434/281; 434/404.

U.S. Pat. No. 4,768,959, “Method of teaching and transcribing of language through the use of a periodic code oflanguage elements” Sep. 6, 1988. Inventors: Sprague, Robert; Sprague, Joan. Current US Classification: 434/156; 283/46; 283/115; 434/167; 434/185.

U.S. Pat. No. 5,752,021, “Document database management apparatus capable of conversion between retrieval formulae for different schemata”, May 12, 1998. Inventors: Nakatsuyama, Hisashi; Okumura, Yo; Uchida, Go. Current US Classification: 707/5; 707/2; 707/6; 707/100.

### BRIEF SUMMARY OF THE INVENTION

The schemata of the elements are presented in a restructured manner that is novel and non-obvious. This is confirmed by the fact that, no one has devised a table in a progressive atomic numerical order of the elements, which renders the patterns of behavior of the elements into color-coded images. After thousands upon thousands of dissertations and published works in the fields of chemistry and physics, the conventional periodic table still contains an interrupted numerical order. The schemata of the elements and of the periodic table of the elements reveal a novelty and non-obviousness nature in its unique schema design.

The schemata of the elements present each aspect of the atomic elements on a progressive numerical schema, which produces visual patterns that have gone unnoticed in the scientific and technical literature for the past 150 years. Unlike the conventional periodic table, which breaks up the numerical order, by placing the Lanthanide and the Actinide series outside the main body of elements, the schemata of the elements clearly define the placement of the different groups and families of elements.

All of the groups and families on the schemata are placed within the main body of the schema design, thus reducing the gaps among the elements. There are now no gaps between the representational elements (the first twenty elements), and less significant gaps between the secondary and tertiary elements. Furthermore, elements 71 and 103 are determined on the schemata to their correct placement, which are significantly misplaced on the conventional periodic table of the elements. In fact, the conventional periodic table of the elements places these two elements in many different localities, causing significant confusion as to their proper destination on the old table.

The Mendeleev-based periodic table of the elements that is currently in use, presents certain limitations in format. The conventional periodic table impedes viewing certain patterns within the behavior of the elements and their atoms. The traditional periodic table presents a dismembered format in its layout, as it is interrupted the Lanthanide Series and the Actinide Series, which remain outside the main body of the table. When these two series are brought into the “long table”, enormous gaps open up among the representative elements, thus denying any possibility of visualizing patterns among the elements on the conventional periodic table.

In effect, the numerical, progressive ordering of the atomic number of the elements is thereby interrupted. The very defining characteristics of the elements and their atoms, that of periodicity, is denied by the dismembered format of the conventional periodic table.

In order to overcome these shortcomings of the conventional periodic table, we are presenting a rearrangement of the elements in a compact schematic design. We refer to the format's design as the schema, whereby the schemata treat many more aspects and characteristics of the elements, than simply that of their periodicity. In this sense, the schemata move beyond the periodic table.

We shall offer a summary view of how to read the schemata As may be readily observed, the schema design maintains smaller gaps among the elements, which now lie between the transition elements. The defining feature of the schemata is that the progressive, sequential numbering of the atomic numbers is now maintained. Patterns among the representative elements are now visible, as well as original patterns between these and the transition elements. These patterns are not available on the conventional table.

Furthermore, the schematic format allows for making projections of the elements projected up to 166-schema and 216-schema.formats. The schema is based upon a series of squares that may be assigned different fill-in colors, and have specific data imprinted within them. This commonly employed visual feature becomes effective in creating a periodic table that may serve as a visual aid in either teaching and or learning about the behavior of the elements and their atoms. The fact that the schema maintains the sequential numbering order of the atomic numbers of the elements, is what shall define the possibility of producing color-coded, visual images upon the schemata.

### BRIEF DESCRIPTION OF THE SEVERAL VIEWS OF THE DRAWINGS

The schema design presents the symbolic representation of the elements in color-coded squares, in a sequential, numerical order from one through 504 elements, in a manner and format as depicted in the drawings presented herein (Drawings Nos. 1 and 5). The drawings are obvious in this respect and supersede the need for a descriptive explanation of the format. The schema format follows the customary direction in visual charts and texts, from left-to-right, and from top-to-bottom (Drawing No. 4), although, other directions are provided for languages other than English, which read from right-to-left.

The schema resolves many interpretative questions within the field of chemistry and physics, which have gone unresolved with the conventional periodic table of the elements. The progressive sequential, numerical ordering of atomic number, now maintained within the schemata, produce symmetrical patterns among the color-coded squares of the elements (Drawings Nos. 18-21). The rendering of visual images of the color-coded squares, corresponding to the elements, provide a symbolic representation of the behavior and relationships among the elements, that are impossible to view on the conventional table's dismembered nature.

List of Drawings that accompany this Utility Patent Application:

Drawing Number 1

The Schemata of the Elements

120-Element Schema

Drawing No. 2

The Schemata of the Elements

Inner and Outer Transition Elements

No. 3.—The Schema of the Elements: The Schema Format of 120 Elements

No. 4.—The Schema of the Elements: The Direction in Scrolling and Reading the Schema Format

No.5—The Schema of the Elements, The Families and Groups of Elements: Color Coded Squares and Key

No. 6 Proportional Spacing Among the Representative Elements

No. 7.—Color-Coded Patterns of Symmetry of the Transition Elements in Relation to Metals, Metalloids and Non-Metals

No. 8.—Alternate Color-Coded Patterns of Symmetry of the Shells of the Elements

No. 9.—The Notation of Groups and Families on the Schema

No. 10.—Hydrogen and the Halogens, Top Row Scroll

No. 11 A Schema Scroll

No. 12—The Nitrogen Family Top Row Scroll and the Carbon Family Top Row Scroll

No. 13 A Schema Scroll

No. 14—The Boron Family Top Row Scroll and the Beryllium Family Top Row Scroll

No. 15—A Schema Scroll

No. 16—The Lithium Family Top Row Scroll and the Noble Gases Family Top Row Scroll

No.17.—A Schema Scroll

No.18.—The Schemata of the Elements: Acidity and Basicity and Neither/Nor

No.19.—The Schemata of the Elements: Atomic Radii Divided by Specific Heat Capacity: The Transition Elements

No.20.—The Schemata of the Elements: Electron Affinity

No.21.—The Schemata of the Elements: A Schema Scroll with Data (Ionization Potentials)

No. 22 Horizontal Scrolling of the Schemata

No. 23—The Schemata of the Elements An Example of Horizontal Scrolling of Outer Transition and Representative Elements

No. 24.—The Schemata of the Elements: A Projection of 166 Elements

No. 25.—The Schemata of the Elements: A Projection of 216 Elements (Odd & Even Numbers)

No. 26.—The Schemata of the Elements: A Projection of 216 Elements (Quaternary Group)

No. 27 The Projection of the Schemata: Elements 216-344 (Cycle 6.0)

No. 28 The Projection of the Schemata: Elements 345-504 (Cycle 7.0)

No. 29 The Projection of the Schema: Elements 215-502

As may be observed in Drawing No. 3, the schema presents a grid-like system of squares, whereby each square represents a specific element. The schema is based upon a placement of the elements according to their electron configuration. Physicists generally perceive “irregularities” in the electron configuration of the atoms. These so-called irregularities are set aside in the schema. The distinctive format of the schema visualizes what the electron count may have become had the irregularities not occurred. The visual ordering of the schema may be presented in different ways, whereby the rows and columns of squares of the schema may be scrolled or wrapped around one another in different directions, that is, vertically or horizontally (Cfr., Drawings Nos. 10-17 inclusive).

The schema, as illustrated in Drawing No.2, is read incrementally from left-to-right and from top-to-bottom in a progressively, sequential numerical ordering. The inverse directions in reading the schema would represent a decremental reading of the schema. Given the fact that all elements are relational to one another, the initial incremental and decremental ordering of the atomic numbers constitute the initial method for rendering data related to the elements on the schema.

The schema presents a 120-element format, as illustrated in Drawing No. 1, based upon the atomic numbers of the elements, and presented according to their electron configuration. The gaps among the transitional elements are much smaller than the gaps among the representational elements on the conventional periodic table. The schema follows the progression of atomic numbers of the elements from left-to-right and from top-to-bottom. The fact that the schema is based upon a progressive order, however, now makes it possible to present the schemata in many different directions, for ease of reading in other languages than English. The schemata are suitable for presentation in languages such as Arabic and Hebrew (from right-to-left), and for Chinese (from top-to-bottom in a vertical format).

The Mendeleev-based table supposedly follows a progressive numbering system (aufbau), but then contradicts that proposition by offering either a fragmented or over-extended placement of some the elements outside the boundaries of the conventional table. The conventional periodic table does not maintain the aufbau design, since the outer transition elements (the lanthanide and the actinide series) lie outside the main body of the elements. Unlike the Mendeleev-based periodic table, the schemata actually maintain the visualization of the sequential, progressive numbering of the atoms, no longer contradicting the progressive, aufbau numbering system.

The distinctive arrangement of the elements by their atomic number within the schema creates a new and original notation of the families and groups of the elements, as illustrated in Drawing No.4. The sequential numerical ordering of the new notation of families and groups consists of fourteen different series of related elements. A specific family or group shares the same number on the schema. The sequential, progressive ordering is to be read from top to bottom, beginning on the left-hand side of the schema at the first square with the number one in it, thus representing the element of Hydrogen. By arranging the elements in this manner on the schema, something quite significant appears. The spatial representation of “periodicity” becomes visible within the schema, as shown in Drawing No.7. On the conventional periodic table, there is no visual representation of the periodicity between the elements. Note the group represented by Lithium (number 3), reading all of the ‘threes’ from left to right.

A significant pattern of symmetry on the schema concerns the ordering of the odd and even numbers of the atomic number of the elements (Cfr., Drawing No.25). This pattern concerns the stable isotopes. Any data rendered upon the schema concerning the characteristics and behavior of the elements and their atoms produces a new and original pattern of symmetry. The schema renders and illustrates old, classical data into color-coded, specific patterns, as well as, producing new, original patterns of symmetries and anomalies. The visual, color-coded patterns derived from the schema's design and spatial placement of the elements may assist students in remembering the innumerable relationships and infinite amount of data. The pattern imaging promotes recall of the schema. Furthermore, the visual, color-coded patterns lay the groundwork for recuperating the predictability within the behavior of the elements, which in turn allows for extrapolating data into projections upon the schema's format, as illustrated in Drawing No. 8 In other words, the 120-element pattern suggests the projection of that same pattern towards the 166-element and 216-element schemata.

The periodicity of the elements may now be visualized in terms of proportion on the schema's format. The periodicity of the elements concerns the manner in which the shells and sub-shells of the atoms are filled by electrons. The periodicity of the electron configuration constitutes the basis for the ordering of the placement of the elements on the schema. Such an elementary pattern of proportionality is simply unavailable on the conventional periodic table now in use today.

The elements are placed in an order of periodic spacing and proportionately established according to the different sectors. The pattern according to the sectors (2.8.8.18.18.32.32.2) reflects the number of elements per sector on the schema. This ordering now allows us to effect projections of the sequential/incremental placement of the possible extension of the schema and the elements that may follow within the schema's format. The representational elements reflect proportional spacing on the schema's format, and the Inner Transition and Outer Transition elements are effectively isolated from the representational elements, while also presenting their own group patterns of symmetry. The so-called irregular elements (the transition and inner transition elements) thus listed on conventional periodic tables, present in fact quite regular patterns when rendered onto the schema format.

A reading of the primary pattern, or the representative elements produces a definite pattern of proportional symmetry. The schema allows for isolating and treating a particular group or family of elements irrespectively of the other groups and families. The representational elements, for example, may be isolated from the rest of the elements on the schema, and thereby specific patterns may be visualized for each family or group (Drawing No. 6). Particular relationships among the elements may be isolated and highlighted in a search for imaging patterns. The different families and groups are assigned specific colors, thus creating specific patterns, drawing attention to specific relationships among the elements and their atoms.

The transition elements and the inner transition elements may be isolated in this manner from the representative elements. The representative elements are known as the primary pattern; the transition elements are known as the secondary pattern; and, the inner transition elements (The Lanthanide and the Actinide Series) are known as the tertiary pattern.

Physicists and chemists often refer to the secondary and tertiary elements as presenting an “irregular” pattern. However, the pattern on the schema reflects quite a regular and predictable pattern, as illustrated in Drawing No. 9. Therefore, a reading of the periodic table of the elements as rendered on the schemata corrects our view of matter-energy. What has often been conceived as being random-like behavior in matter-energy, may now be conceived for what it is; something quite regular and predictable. The parameters within Nature, according to the patterns derived from the schemata, appear to be well defined, and little seems to be irregular or out of place within the behavior of the elements and their atoms. Word-concepts such as “regular and irregular” become limited in visualizing the behavior of the elements and their atoms once rendered upon the schemata.

The schema allows us to conceptualize the placement of such debated elements as elements numbers 71 and 103. Generally, on the conventional periodic table of the elements, these elements are placed within the outer transition elements, element 71 is placed within the Lanthanide Series, and element 103 is placed within the Actinide Series (Drawing Nos. 2 and 5). According to the schema, the placement of these elements lies within the inner transition elements in a most decisive manner. The schema thus clarifies such points of confusion regarding the arrangement of the elements 71 and 103, as members of the transition elements. The schema's format is therefore self-correcting, since breaks within the incremental or decremental patterns of symmetry are easily discernible. Any violation or deviation of the data is quickly perceived through the symmetry of the pattern being rendered on the color-coded squares of the schema (Cfr., Drawing No. 8).

The schema may be scrolled vertically by rows or, horizontally by columns, in search of specific, color-coded visual patterns, as illustrated in Drawings Nos. 10 through 17, and Nos. 22-23). Horizontal scrolls allow one to relate the super-heavy elements at the end of the schema with the representative elements at the beginning of the schema (Drawing No. 22). An infinite number of relational options become available. In this manner, one particular scroll may not reveal any specific pattern, while a distinct scroll may afford the imaging of a pattern that would otherwise go unrecognized. The dynamics of the schema, therefore, produces an effective mechanism for searching out patterns, as in Drawings Nos. 18 through 21). In this sense, the schemata contradict the commonly held view where the periodic table of the elements is often thought of as there being only one periodic table. It is commonly thought that only one correct periodic table of the elements exists. When, in fact, what exists is the possibility of presenting the elements and their atoms in as many formats and relationships as exist within their very nature on the schema format. The vertical and horizontal scrolls of the schemata reflect the dynamic nature of the behavior of the elements and their atoms.

The schemata of the elements are also presented in schemata containing elements 120 (Drawing No. 5); 166-168 elements (Drawing No.24); 216-218 elements (Drawings Nos. 25-26); and 502-504 elements (Drawings Nos. 27-29). The cut-off points at specific elements depend upon whether a new cycle originates at that number of element or not; for example, cycles begin at elements 166 and 216. This distinction is overlooked by the conventional periodic table, which simply presents projections of the periodic table of 168 and 218 elements. The schema format determines the symmetry of the different cycles in a clear and precise manner based on the color-coded patterns derived thereof

### DETAILED DESCRIPTION OF THE INVENTION

The schema design presents a layout and format of the elements and their atoms based on color-coded squares, symbolically representing each one of the elements and their atoms of the periodic table of the elements. The schemata are generally presented in groups of 92, 109, 120, 166, 216, and 502 elements, with specific variations between these particular numbers, up to and including 504 elements.

The progressive, sequential, numerical order of the elements, according to their atomic number (beginning with Hydrogen, element number 1), is presented from left-to-right, in eight rows of elements, and with the necessary number of columns of elements, reaching up to and including element 504. The primary, secondary, and tertiary groups are maintained with slight modifications of the inner and outer transition elements (numbers 71 and 103), as well as, theoretically identifying and illustrating the quaternary group of elements. The schema format also derives those groups related to the quintuplicate and sextuplicate groups of elements (Drawings Nos. 27-28).

The termination of the electronic configuration of the elements is employed to determine the placement of each element on the schema design. Unlike the conventional periodic table of the elements, an horizontal format is utilized, and the elements that pertain to the inner and outer transitional groups are placed within the main body of the elements. By placing the inner and outer transitional elements within the main body of the schema of elements, the progressive, sequential, numerical ordering is respected and maintained. The schema design allows for a comparative analysis of the behavior and relationship of the elements. By relating the color-coded squares to one another, visual images are rendered into patterns on the schema, which afford the quality of predicting the subsequent placement of super-heavy elements on the schema.

The rows and columns of color-coded squares, representing the different elements and their atoms of the periodic table, may be scrolled either horizontally or vertically. The horizontal and vertical scrolling of the squares may be effected either by a single square or by groups of squares (by entire rows and columns). The scrolling mechanism renders an infinite number of color-coded, visual patterns, which identify and illustrate the incremental and decremental tendencies among the elements and their atoms (as illustrated in Drawings Nos. 10-17, and 22-23).

What I claim as my invention is:

1.- The schemata of the elements are based upon and produce a progressive numerical order and design where the atomic numbers of the elements (numbers one through 504) are offered in an unbroken sequential, numerical progression, which produces original color-coded patterns based on translation and reflective symmetry regarding the behavior of the elements and their atoms.

2.- The color-coded squares of the schemata of the elements are placed in horizontal rows of eight elements, with varying numbers of elements in each vertical column, whereby data transferred onto the rows and columns of elements, produce relationships based on the incremental and decremental values assigned to the different aspects, features and characteristics of the elements and their atoms.

3.- The enclosed progressive numerical format of the schemata of the elements presents color-coded squares representing each atomic element, whereby the squares may be scrolled horizontally and vertically, in order to discern and thus illustrate the salient, characteristic features of the elements and their atoms.
